(19) United States
(12) Patent Application Publication
(10) Pub. No.: US 2003/0090588 A1
(43) Pub. Date: May 15, 2003

(54) Apparatus of a capsule form digital camera

(76) Inventor: Chin-Shu Wu, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/986,838

(22) Filed: Nov. 13, 2001

(51) Int. Cl. H04N 5/225

(52) U.S. Cl. 348/373

(57) ABSTRACT

This invention relates to an apparatus of a digital camera, more particularly to an apparatus to a capsule form digital camera. A shape of the capsule form digital camera of the present invention is like a capsule. An inside of the capsule form digital camera comprises a camera shutter module, a liquid crystal display (LCD) module, and a main circuit module. The camera shutter module is used to control the time of the exposure process of the capsule form digital camera. The liquid crystal display module is used to show using data of the capsule form digital camera. The main circuit module is used to control a power supply and related circuits of the capsule form digital camera. The main circuit module comprises a cell and this cell is a lithium cell, which can be electrified. When the capsule form digital camera of the present invention is connected with a computer whose power is opened by using a universal serial bus (USB) connector, the lithium cell will proceed a electrifying process by using the universal serial bus connector to transmit current from the computer.

### BACKGROUND OF THE INVENTION

1. Field of the Invention

This invention relates to an apparatus of a digital camera, more particularly to an apparatus to a capsule form digital camera to reduce a volume and a using cost of the capsule form digital camera.

2. Description of the Prior Art

A digital camera is an apparatus, which uses digital data to save images that are got in the shooting process. The digital camera can use a disc, which can be used to save images, or a personal computer memory card international association (PCMCIA) card to save static images. In order to economize memory space of saving image data, the images, which are got from the digital camera, are saved in a compression file mode, such as a file format of a joint photographic experts group (JPEG) file. The shot photographs, which are got from the digital camera, will be transmitted from the digital camera to the computer by using a printer port or a communication port of a recommended standard-232 (RS-232) to proceed a image process. The image data, which are saved in the computer, will be printed by using printers and will not be printed by using developing and printing steps of traditional camera. The digital camera also has no problem in a negative. Therefore, digital cameras are used gradually in the shooting picture.

At present, dots per inch (dpi) of the digital camera still have a difference to the traditional camera, which uses a negative. Especially at a place with a not enough light source, the dots per inch (dpi) of the digital camera are worse than the traditional camera. But the digital camera usually has a liquid crystal display to preview the image. A user can view the shot photograph by using the liquid crystal display immediately after taking a picture. The shot image will be deleted by using this liquid crystal display. The traditional camera does not have this advantage of the digital camera.

The digital camera has another name in digital still camera (DSC) to make the differentiation from the digital random camera. At present, a charge-coupled device or a complementary metal-oxide semiconductor (CMOS) is used in the digital camera to get images and to transform image data, which are only got by using the traditional photograph, to become digital image data.

Referring to FIG. 1, this shows a base component structure diagram of one of traditional digital cameras. A power of the traditional digital camera is a dry cell or an alkaline cell. Therefore, a base structure of the traditional digital camera comprises a battery container 10 to fix the cell. The traditional digital does not comprise a charged function. Therefore, a user must change the cell to keep the normal function of the traditional digital camera, when the power of the cell is exhausted. The traditional digital camera also comprises a motherboard container 20 to fix a motherboard 22, which is used to control the proceeding of the traditional digital camera. The motherboard 22 comprises a circuit controller, a memory, and a thin-film transistor (TFT) 24 to bring normal functions of the traditional digital camera into full play and to save digital image data, which are got from the traditional digital camera, in the memory. The battery container 10 and the motherboard container 20 of the base structure of the traditional digital camera are connected with each other.

The thin-film transistor 24, which is fixed on the motherboard 22, is located between the motherboard 22 and motherboard container 20 to provide the using data of the traditional digital camera for users and to make the users operate the traditional camera more conveniently. After fixing the motherboard 22 on the base structure of the traditional digital camera, a camera lens 28 is fixed on the motherboard by using a camera lens frame to get the image data from the camera lens. The base structure of the traditional digital camera comprises a camera shutter 30 and a viewfinder module 35. The camera shutter 30 is fixed on the base structure of the traditional digital camera and is connected with the motherboard 20. When the user decide a scenery which he or she wants to get by using the viewfinder module 35, the user can use the camera shutter 30 to control the camera lens 28 and the exposure time to get the image of the scenery. The image, which is got by using the camera lens 28, will be transformed to become the digital image data by the motherboard 22 and the digital image data will be saved in the memory of the motherboard 22.

Referring to FIG. 2, this shows a general assembly diagram of the traditional digital camera. When all elements are fixed on the base structure of the traditional digital camera, the first case 40 is connected with the base structure of the traditional digital camera and the second case 45 is connected with the first case 40 to finish the process of fabricating the traditional digital camera. The first case 40 is used to fix and to protect the elements, which are assembled on the base structure of the traditional digital camera. The second case 45 is used to make an appearance of the traditional digital camera become more beautiful and to increase an aseismatic ability of the traditional digital camera.

Because the dry cell or the alkaline cell is used to be the power of the traditional digital camera, the structure of the traditional digital camera must comprise a battery container to fix the dry cell or the alkaline cell. This condition will not reduce a volume of the traditional digital camera and will decrease the convenience of the traditional digital camera. When the power of the dry cell or the alkaline cell traditional digital camera is exhausted, the user must change a new cell and can not proceeding the electrifying process to the used cell in the traditional digital camera. This condition will increase the economical cost of the user and will destroy an environmental protection. In the traditional digital camera, all circuits are designed on the motherboard and will make the volume of the traditional digital camera not be reduced. When the traditional digital camera has a breakdown, the user usually changes the motherboard. This condition will also increase the economical cost of the user.

### SUMMARY OF THE INVENTION

In accordance with the above-mentioned invention backgrounds, the huger volume of the traditional digital camera will decrease the using convenience and will increase the economical cost of the user. The present invention provides an apparatus of a capsule form digital camera to decrease the volume of the digital camera by using the lithium cell, which can be electrified, a main circuit module, a camera shutter module, and a liquid crystal display module.

The second objective of this invention is to promote the environmental protection by using the lithium cell, which can be electrified, a main circuit module, a camera shutter module, and a liquid crystal display module.

The third objective of this invention is to decrease the economical cost of the user by using the lithium cell, which can be electrified, a main circuit module, a camera shutter module, and a liquid crystal display module.

It is a further objective of this invention to increase the using convenient of the digital camera by using the lithium cell, which can be electrified, a main circuit module, a camera shutter module, and a liquid crystal display module.

In according to the foregoing objectives, the present invention provides an apparatus of a capsule form digital camera to increase the using convenience of the digital camera. A shape of the capsule form digital camera of the present invention is like a capsule. An inside of the capsule form digital camera comprises a camera shutter module, a liquid crystal display module, and a main circuit module. The camera shutter module is used to control the time of the exposure process of the capsule form digital camera. The liquid crystal display module is used to show using data of the capsule form digital camera. The main circuit module is used to control a power supply and related circuits of the capsule form digital camera. The main circuit module comprises a cell and this cell is a lithium cell, which can be electrified. When the capsule form digital camera of the present invention is connected with a computer whose power is opened by using a universal serial bus (USB) connector, the lithium cell will proceed a electrifying process by using the universal serial bus connector to transmit current from the computer. a volume of the lithium cell of the present invention is smaller than the common dry cell and the alkaline cell. Therefore, the volume of the capsule form digital camera of the present invention is smaller than the traditional digital camera to increase the using convenience of the capsule form digital camera. The power of the present invention is the lithium cell, which can be electrified, therefore, using the capsule form digital camera will promote the environmental protection and will decrease the economical cost of the present invention. The capsule form digital camera of the present invention uses the main circuit module, the camera shutter module, and the liquid crystal display module to bring its efficiency into full play. When several elements of the capsule form digital camera is breakdown, the user will only maintain the relative module to reduce the cost of the maintaining process.

### BRIEF DESCRIPTION OF THE DRAWINGS

In the accompanying drawing forming a material part of this description, there is shown:

FIG. 1 shows a base component structure diagram of one of traditional digital cameras;

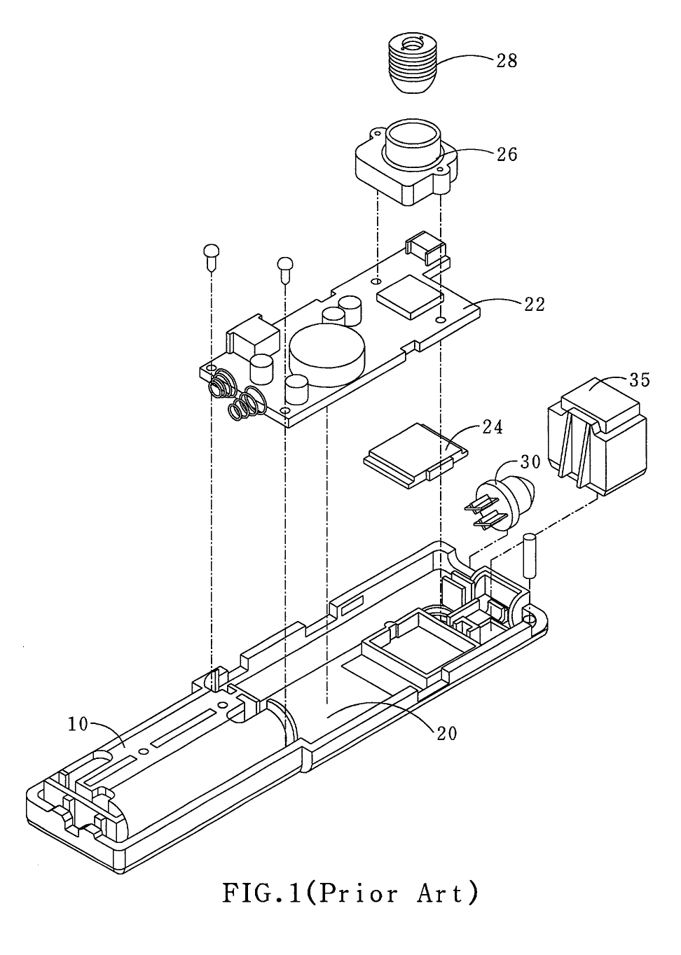

FIG. 2 shows a general assembly diagram of the traditional digital camera;

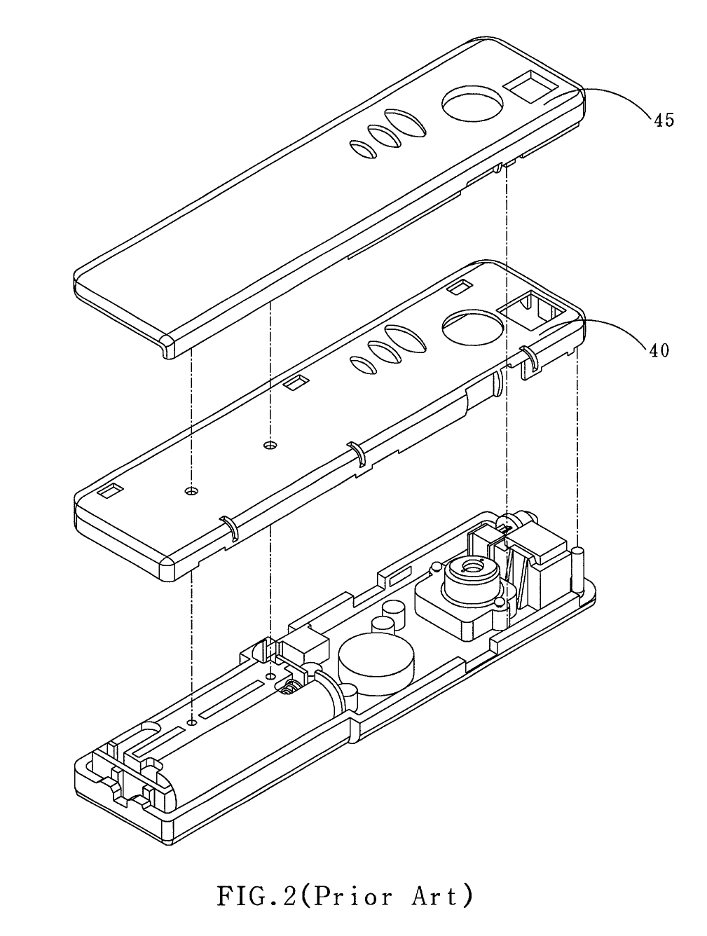

FIG. 3 shows a diagram of the main circuit module and the camera shutter module on the first surface of the main circuit module;

FIG. 4 shows a diagram of the main circuit module and the camera shutter module on the second surface of the main circuit module;

FIG. 5 shows a diagram in fixing the liquid crystal display module in the first case of the present invention.

FIG. 6 shows a diagram in fixing the main circuit module in the first case of the present invention; and

FIG. 7 shows a general assembly diagram of the capsule form digital camera of the present invention.

### DESCRIPTION OF THE PREFERRED EMBODIMENT

The foregoing aspects and many of the attendant advantages of this invention will become more readily appreciated as the same becomes better understood by reference to the following detailed description, when taken in conjunction with the accompanying drawings, wherein:

A shape of the traditional digital camera is a square and a power of the traditional digital camera is a dry cell or an alkaline cell, therefore, a volume of the traditional digital camera can not be reduced successfully. Circuits of the traditional digital camera are always fabricated in a single motherboard, therefore, a inside space of the traditional digital camera will not be used nimbly and the volume of the traditional digital camera can not be reduced successfully. The present is to provide a capsule form digital camera, which comprises a camera shutter module, a liquid crystal display module, a main circuit module, and a lithium cell that can be electrified. The camera shutter module, the liquid crystal display module, and the main circuit module of the present invention are used to control the performance of the capsule form digital camera and to improve the inside space of the capsule form digital camera following needs of the product. These modules will further be used to reduce the volume of the capsule form digital camera.

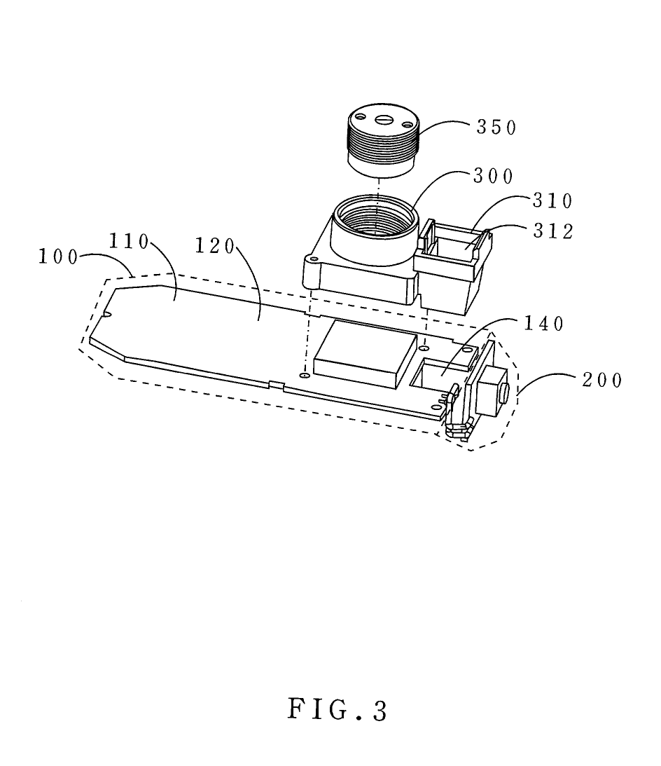

Referring to FIG. 3, this shows a diagram of the main circuit module and the camera shutter module on the first surface of the main circuit module. The main circuit module 100 of the present invention is connected with the camera shutter module 200 by using the first connection port. The main circuit module comprises a motherboard 110, the first connection port, the second connection port, and the first viewfinder hole 140. The motherboard 110 comprises a processor and a memory to deal with image data and to save the image data. A camera lens frame 300 and a viewfinder frame 310 are fixed on the first surface 120 of the main circuit module 100. A camera lens 350 is fixed on the first surface 120 of the main circuit module 100 by using the camera lens frame 300 and is connected with the main circuit module 100 by using a transport line. A focal length of the camera lens is about up to 60 centimeter and dots per inch of the camera lens are about 1 hundred thousand to 3 hundred thousand pixels. In the present invention, the viewfinder frame 310 can be connected with the camera lens frame 300 to become a element of the capsule form digital camera but this will not limit the scope of the present invention. Following the camera lens frame 310 is fixed on the first surface of the main circuit module 100, the viewfinder frame 310 is fixed in the first viewfinder hole 140, which is on the first surface of the main circuit module 100. Viewfinder frame 310 comprises the second viewfinder hole 312 and the third viewfinder hole. The camera shutter module 200, which comprises a camera shutter, is used to control the exposure time of the capsule form digital camera. The exposure time of the camera shutter module 200, which is used in the capsule form digital camera of the present invention, is about 1/25 to 1/1000 seconds. But this exposure time will not limit the scope of the present invention.

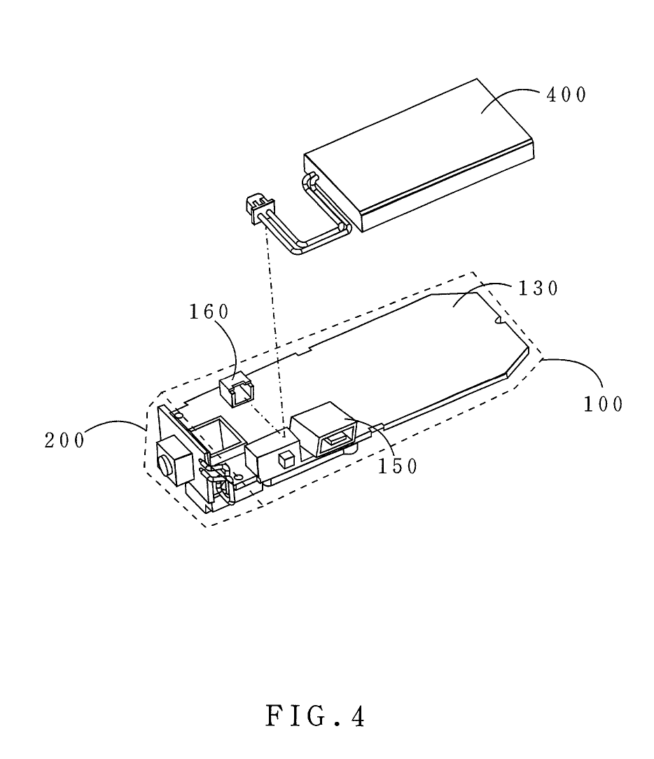

Referring to FIG. 4, this shows a diagram of the main circuit module and the camera shutter module on the second surface of the main circuit module. When the camera shutter module 200 is connected with the main circuit module 100 and the camera lens frame, the viewfinder frame, and the camera lens are assembled on the first surface of the main circuit module 100, a cell is assembled on the second surface 130 of the main circuit module 100 to provide a power to the capsule form digital camera and to make the capsule form digital camera bring its normal performance into full play. The second surface 130 of the main circuit module comprises a universal serial bus (USB) connector 150 to transmit image data from the capsule form digital camera to the computer. The universal serial bus connector can be also used to electrify the cell of the capsule form digital camera. The second surface 130 of the main circuit module further comprises a cell connector 160 to make the cell 400 and the main circuit module 100 are connected with each other. The cell of the present invention is a lithium cell, which can be electrified. A capacity of the lithium cell, which can be electrified, of the present invention is about 170 micro-amperes/hour and this capacity will not limit the scope of the present invention. When the lithium cell, which can be electrified, is used in the capsule form digital camera of the present invention, the capsule form digital camera will be used continuously about one week without electrified. In usual, inside of the universal serial bus connector comprises two kinds circuit. One is used to transmit the image data from the capsule form digital camera to the computer and the other one is used to transmit the current from the computer whose power is opened to the capsule form digital camera. Although an amount of the current, which is transmitted from the computer to the capsule form digital camera, is small, the lithium cell, which can be electrified, just can use the current to proceed the electrifying process. In the electrifying condition, the lithium cell, which can be electrified, will passing through two hours to fill the power up.

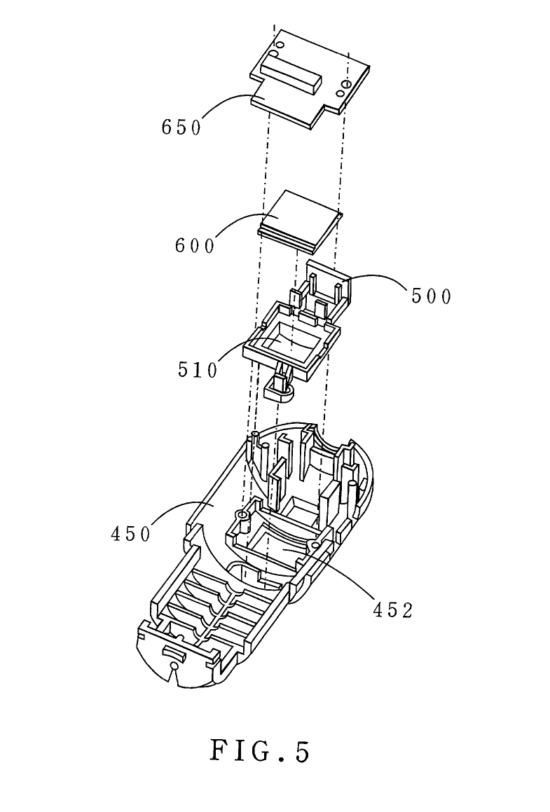

Referring to FIG. 5, this shows a diagram in fixing the liquid crystal display module in the first case of the present invention. A shape of the first case 450, which comprises a plural prop stands to support elements that are fixed in the first case 450, is like an arc. The first case 450 further comprises a liquid crystal display window 452 to make the user read data, which are shown on the liquid crystal display. The liquid crystal display module comprises a window frame 500, a liquid crystal display 600, and a liquid crystal display circuit board 650. At first, the window frame 500 is assembled in the first case 450 and the liquid crystal display 600 is assembled on the window frame 500. The window frame 500 comprises a hole 510, which is used to assemble the liquid crystal display 600. The user will penetrate the liquid crystal display window 452 and the hole 510 to read the data, which is shown on the liquid crystal display 600. At last, the liquid crystal display circuit board 650 is connected on a side of the liquid crystal display 600 to control the liquid crystal display 600. The liquid crystal display circuit board of the liquid crystal display module is usually connected with the main circuit module to show the condition of the capsule form digital camera on the liquid crystal display and to let the user read it.

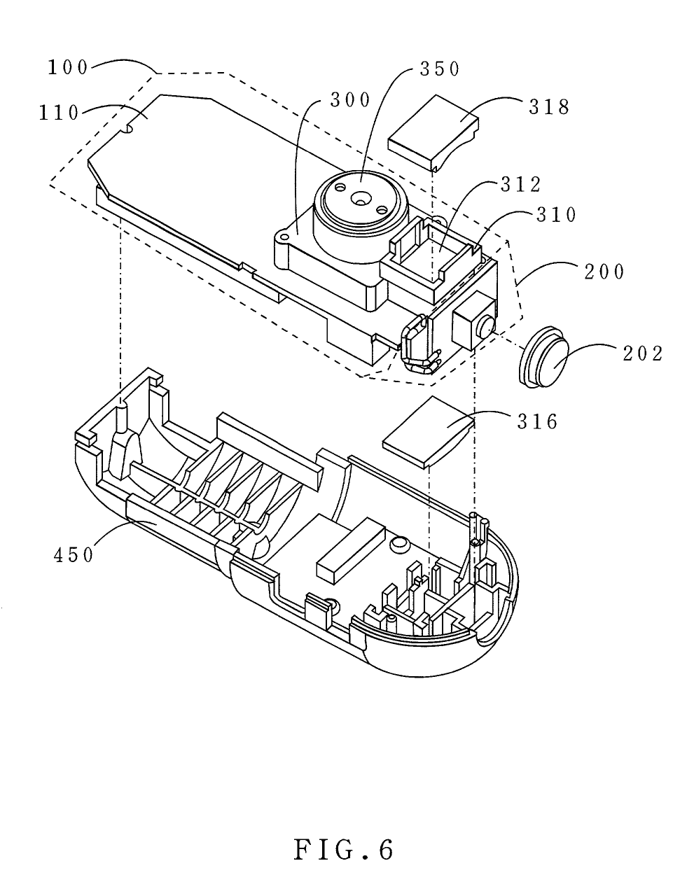

Referring to FIG. 6, this shows a diagram in fixing the main circuit module in the first case of the present invention. After the main circuit module is connected with the camera shutter and the cell, the camera lens frame 300, the viewfinder frame 310, and the camera lens 350 are assembled on the main circuit module, the main circuit module is assembled in the first case 450, wherein the liquid crystal display module is assembled in the first case 450. The main circuit module is connected with the liquid crystal display module by using the second connection port. Before the main circuit module is assembled in the first case 450, the first lens 316 is assembled between the main circuit module 100 and the first case. The first lens 316 is located on the hole of the first case 450 and the second viewfinder hole 312. After the main circuit module is assembled in the first case 450, a camera shutter key is assembled on the camera shutter of the camera shutter module to increase the convenience of the user. Then the second lens 318 is assembled on the third viewfinder hole. When the capsule form digital camera is used, the first lens 316 is near the user's eyes and a convex lens is used to be the first lens. The second lens is near the object, which the user wants to shoot, and a concave lens is used to be the second lens 318.

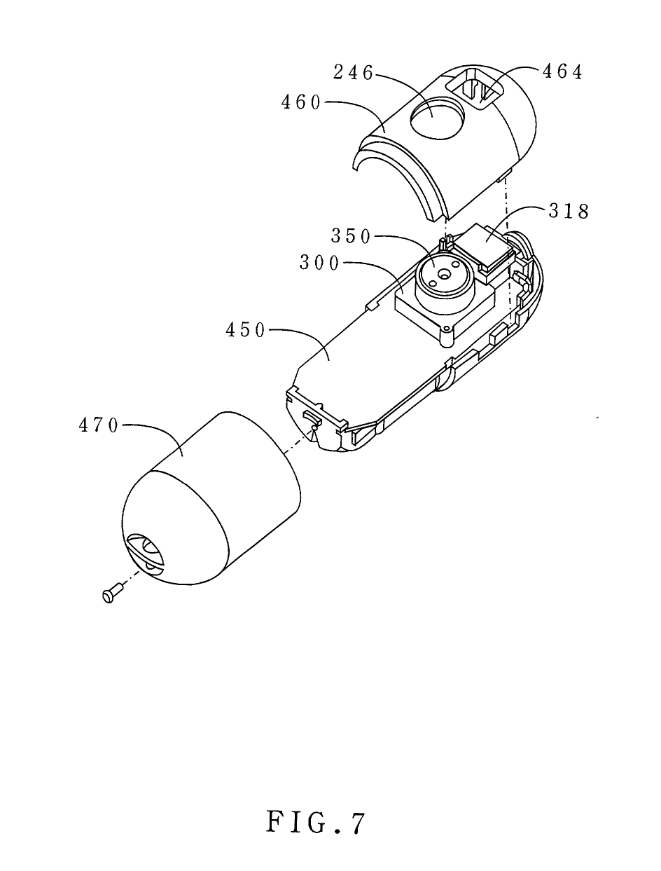

Referring to FIG. 7, this shows a general assembly diagram of the capsule form digital camera of the present invention. After all elements are assembled in the first case, the second case 460 is connected with the partial first case. A shape of the second case is like an arc and the second case 460 comprises a camera lens hole 462 and the fourth viewfinder hole 464. The camera lens hole 464 is used to show the camera lens to bring normal performances of the capsule form digital camera into full play. The fourth viewfinder hole is used to make the user observe the object, which he or she wants to shoot, by using the viewfinder. In usual, there is a piece of plastic, whose shape is like an arc and size is the same as the fourth viewfinder hole 464, on the fourth viewfinder hole 464 to beautify the appearance of the capsule form digital camera and to make the appearance of the capsule form digital camera become more smooth. After the second case 460 is connected with the first case, the partial first case is placed into the third case 470, wherein a shape of the third case is like a sleeve. The first case 450, the second case 460, and the third case 470 are connected with each other to become a capsule form appearance and to form a closed space whose form is like a capsule form.

When the capsule form digital camera is breakdown, the user can disassemble the first case, the second case, and the third case to detect the performance of each module. When the user find that one of the modules is breakdown, the user will only change the module to restore the original performance of the capsule form digital camera and will not change all modules. The lithium cell, whose size is smaller and can be electrified, is used in the capsule form digital camera to reduce the volume of the capsule form digital camera and to increase the convenience of the user. When the user transmit image data from the capsule form digital camera to the computer by using the universal serial bus connector, the lithium cell will be electrified by using universal serial bus connector at the same time. This condition will increase the using efficiency of the capsule form digital camera. When the power of the capsule form digital camera is exhausted, the lithium cell also can be electrified by using the universal serial bus connector to obtain the performance of the capsule form digital camera. The lithium cell, which is charged by using the universal serial bus connector, is used in the capsule form digital camera of the present invention, therefore, the capsule form digital camera will be charged without using a battery charger. This condition will increase using conveniences of the user.Because the capsule form digital camera of the present invention uses the lithium cell, which can be electrified, to obtain its performance, this condition will conform to the environmental protection and needs of society and to decrease the economical cost of the user.

In accordance with the present invention, the present invention provides an apparatus of a capsule form digital camera to increase the using convenience of the digital camera. A shape of the capsule form digital camera of the present invention is like a capsule. An inside of the capsule form digital camera comprises a camera shutter module, a liquid crystal display module, and a main circuit module. The camera shutter module is used to control the time of the exposure process of the capsule form digital camera. The liquid crystal display module is used to show using data of the capsule form digital camera. The main circuit module is used to control a power supply and related circuits of the capsule form digital camera. The main circuit module comprises a cell and this cell is a lithium cell, which can be electrified. When the capsule form digital camera of the present invention is connected with a computer whose power is opened by using a universal serial bus (USB) connector, the lithium cell will proceed a electrifying process by using the universal serial bus connector to transmit current from the computer. a volume of the lithium cell of the present invention is smaller than the common dry cell and the alkaline cell. Therefore, the volume of the capsule form digital camera of the present invention is smaller than the traditional digital camera to increase the using convenience of the capsule form digital camera. The power of the present invention is the lithium cell, which can be electrified, therefore, using the capsule form digital camera will promote the environmental protection and will decrease the economical cost of the present invention. The capsule form digital camera of the present invention uses the main circuit module, the camera shutter module, and the liquid crystal display module to bring its efficiency into full play. When several elements of the capsule form digital camera is breakdown, the user will only maintain the relative module to reduce the cost of the maintaining process.

Although specific embodiments have been illustrated and described, it will be obvious to those skilled in the art that various modifications may be made without departing from what is intended to be limited solely by the appended claims.

What is claimed is:

1. An apparatus of a capsule form digital camera, said apparatus comprises:
a first case, wherein a shape of said first case is a sleeve;
a second case, wherein a shape of said second case is an arc and is connected with said first case;
a third case, wherein a shape of said third case is an arc and is connected with said first case and said second case to form a closed space whose shape is a capsule form;
a main circuit module, wherein said main circuit module is located into said closed space and comprises a motherboard to deal with a digital image datum;
a camera shutter module, wherein said camera shutter module is located into said closed spaced and is connected with said main circuit module to control a exposure time of said capsule form digital camera;
a lithium cell, wherein said lithium cell is located into said closed space and is connected with said main circuit module to provide a power for said capsule form digital camera;
a universal serial bus connector, wherein said universal serial bus connector is located into said closed space and is connected with said main circuit module to transmit said digital image datum and a current;
a liquid crystal display module, wherein said liquid crystal display module is located into said closed space and is connected with said main circuit module to provide a condition of said capsule form digital camera; and
a camera lens frame, wherein said camera lens frame is located in said closed space to assemble a lens.

2. The apparatus according to claim 1, wherein said partial second case is in said first case.

3. The apparatus according to claim 1, wherein said third case comprises a camera lens hole.

4. The apparatus according to claim 1, wherein said lithium cell can be electrified.

5. The apparatus according to claim 4, wherein said lithium cell which can be electrified can use said universal serial bus to proceed a electrifying process.

6. An apparatus of a capsule form digital camera, said apparatus comprises:
a first case, wherein a shape of said first case is an arc;
a main circuit module, wherein said main circuit module is assembled in said first case and comprises a motherboard to deal with a digital image datum;
a camera shutter module, wherein said camera shutter module is assembled in said first case and is connected with said main circuit module to control a exposure time of said capsule form digital camera;
a universal serial bus connector, wherein said universal serial bus connector is located on said main circuit module and is connected with said main circuit module to transmit said digital image datum and a current;
a lithium cell which can be electrified, wherein said lithium cell which can be electrified is located on said main circuit module and is connected with said main circuit module to provide a power for said capsule form digital camera and to proceed a electrifying process by using said current;
a liquid crystal display module, wherein said liquid crystal display module comprises a liquid crystal display and a liquid crystal display circuit board and is connected with said main circuit module to provide a condition of said capsule form digital camera; and
a camera lens frame, wherein said camera lens frame is located on said main circuit module to be used to assemble a camera lens.
a second case, wherein a shape of said second case is an arc and is connected with said partial first case; and
a third case, wherein a shape of said third case is a sleeve and is connected with said first case and said second case to form a capsule form.

7. The apparatus according to claim 6, wherein said partial first case is in said third case.

8. The apparatus according to claim 6, wherein said second case comprises a camera lens hole.

9. The apparatus according to claim 6, wherein a first lens is located between said first case and said main circuit module.

10. The apparatus according to claim 9, wherein said first lens is a convex lens.

11. The apparatus according to claim 6, wherein a second lens is located between said second case and said main circuit module.

12. The apparatus according to claim 11, wherein said second lens is a concave lens.

13. An apparatus of a capsule form digital camera, said apparatus comprises:
a first case, wherein a shape of said first case is an arc
a main circuit module, wherein said main circuit module is assembled in said first case and comprises a motherboard to deal with a digital image datum;
a camera shutter module, wherein said camera shutter module is assembled in said first case and is connected with said main circuit module to control a exposure time of said capsule form digital camera;
a universal serial bus connector, wherein said universal serial bus connector is located on a first surface of said main circuit module and is connected with said main circuit module to be used to connected with a computer and to transmit said digital image datum and a current;
a lithium cell which can be electrified, wherein said lithium cell which can be electrified is located on said first surface of said main circuit module and is connected with said main circuit module to provide a power for said capsule form digital camera and to proceed a electrifying process by using said current;
a liquid crystal display module, wherein said liquid crystal display module comprises a liquid crystal display and a liquid crystal display circuit board and is connected with said main circuit module to provide a condition of said capsule form digital camera;
a camera lens frame, wherein said camera lens frame is located on a second surface of said main circuit module to be used to assemble a camera lens;
a viewfinder frame, wherein said viewfinder frame is located on said second surface of said main circuit module to be used to assemble a first lens and a second lens;
a second case, wherein a shape of said second case is an arc and is connected with said partial first case; and
a third case, wherein a shape of said third case is a sleeve and is connected with said first case and said second case to form a capsule form.

14. The apparatus according to claim 13, wherein said partial first case is in said third case.

15. The apparatus according to claim 13, wherein said second case comprises a camera lens hole.

16. The apparatus according to claim 13, wherein said first lens is located between said first case and said main circuit module.

17. The apparatus according to claim 13, wherein said first lens is a convex lens.

18. The apparatus according to claim 13, wherein said second lens is located between said second case and said main circuit module.

19. The apparatus according to claim 13, wherein said second lens is a concave lens.
